(19) United States
(12) Patent Application Publication
(10) Pub. No.: US 2011/0320424 A1
(43) Pub. Date: Dec. 29, 2011

(54) ASSESSING AND ADAPTING COMPONENT PARAMETERS

(75) Inventors: Jeff A. Zias, Los Altos, CA (US); Peter C. Terrill, San Francisco, CA (US); Judd C. Jacobs, San Jose, CA (US); Joseph W. Wells, III, San Carlos, CA (US); Brian A. Tran, Fremont, CA (US); Hugh N. Molotsi, Cupertino, CA (US)

(73) Assignee: INTUIT INC., Mountain View, CA (US)

(21) Appl. No.: 12/826,479

(22) Filed: Jun. 29, 2010

(51) Int. Cl. G06F 17/30

(52) U.S. Cl. 707/708; 707/E17.108

(57) ABSTRACT

A parameter-selection technique that allows preferred permutations to be rapidly identified based on real-world user behavior is described. In particular, a set of web pages that include different permutations of the set of parameters are generated. Then, at least a subset of these web pages is provided to the users in response to their requests. For example, the requests may be associated with user selections of search results, which are associated with search queries provided by the users to a search engine. While the users interact with the subset of the set of web pages, their actions and the associated context (with respect to the different permutations) are tracked. Next, the tracked user actions are used to identify the web pages associated with the preferred permutations of the set of parameters.

### BACKGROUND

The present disclosure relates to techniques for identifying preferred permutations of a set of parameters, such as those used in a set of web pages.

Although people have ideas for new products all the time, only a small fraction of these products are ultimately successful. Because developing and marketing a product is expensive, companies usually can only pursue a small subset of their new product ideas (thus, there is a significant opportunity cost associated with failed or sub-optimal products). To reduce the likelihood of failure, companies often devote considerable resources to identify products that meet customer needs, and to select product features that customers desire. For example, many companies use focus groups to determine customer needs and to assess the likely success of a given product. However, focus groups can be time-consuming and the results can be unreliable. Consequently, product failures are still common.

Alternatively, some companies run so-called ‘vapor tests,’ in which prototypes of products are tested in the marketplace. However, this approach can be time-consuming, especially when multiple iterations are used to assess product features. These delays can be problematic in dynamic environments, such as the Internet, where a low barrier to entry and a rapid pace of technical innovation give rise to considerable competitive pressure.

### SUMMARY

The disclosed embodiments relate to a computer system that identifies preferred permutations of a set of parameters for web pages. During operation, the computer system generates a set of web pages that include different permutations of the set of parameters. Then, the computer system receives requests from users, which are associated with search queries provided by the users to a search engine. For example, the requests may be associated with selections, by the users, of search results that are associated with the search queries. In response to the received requests, the computer system provides at least a subset of the set of web pages to the users. Next, while the users interact with the subset of the set of web pages, the computer system tracks user actions. The computer system can also use the tracked user actions to identify the web pages associated with the preferred permutations of the set of parameters.

In some embodiments, the computer system optionally receives set-up instructions that specify the set of parameters. Moreover, the computer system may optionally revise the set of web pages based on the tracked user actions. For example, revising the set of web pages may include modifying at least some of the permutations of the set of parameters. These revisions may be performed iteratively to progressively modify at least some of the permutations of the set of parameters based on information that is learned about the users' behaviors when the users interact with the set of web pages (such as from the tracked user actions). Furthermore, the computer system may optionally modify search-engine keywords associated with the set of web pages based on the search results and the user actions.

Note that the set of parameters may include: content, a sensory presentation format, a web-page component and/or a configuration of the web-page component. Moreover, tracking the user actions may involve event tracking. For example, the user actions may include user selections and information provided in fields in the set of web pages. More generally, the user actions may include: context information associated with the permutations of the set of parameters in the subset of the set of web pages, spatial-relationship information for locations that the users interact with relative to the permutations of the set of parameters in the subset of the set of web pages, and temporal information associated with the user interaction with the subset of the set of web pages.

In some embodiments, the computer system optionally analyzes the user actions and the associated permutations of the set of parameters to identify the web pages associated with preferred permutations. For example, the analysis may include natural language processing of content associated with the user actions.

Additionally, the preferred permutations are associated with commercial success of a product. This commercial success may allow an organization (such as a company) to expand its market share. Therefore, the users may be other than existing customers of a product associated with the set of web pages.

Another embodiment provides a method that includes at least some of the operations performed by the computer system.

Another embodiment provides a computer-program product for use with the computer system. This computer-program product includes instructions for at least some of the operations performed by the computer system.

### BRIEF DESCRIPTION OF THE FIGURES

FIG. 1 is a flow chart illustrating a method for identifying preferred permutations of a set of parameters for web pages in accordance with an embodiment of the present disclosure.

FIG. 2 is a flow chart illustrating the method of FIG. 1 in accordance with an embodiment of the present disclosure.

FIG. 3 is a block diagram illustrating a set of web pages in accordance with an embodiment of the present disclosure.

FIG. 4 is a block diagram illustrating a computer system that performs the method of FIGS. 1 and 2 in accordance with an embodiment of the present disclosure.

FIG. 5 is a block diagram illustrating a computer system that performs the method of FIGS. 1 and 2 in accordance with an embodiment of the present disclosure.

FIG. 6 is a block diagram illustrating a data structure for use in the computer system of FIG. 5 in accordance with an embodiment of the present disclosure.

Note that like reference numerals refer to corresponding parts throughout the drawings. Moreover, multiple instances of the same part are designated by a common prefix separated from an instance number by a dash.

### DETAILED DESCRIPTION

Embodiments of a computer system, a technique for identifying preferred permutations of a set of parameters for web pages, and a computer-program product (e.g., software) for use with the computer system are described. This parameter-selection technique allows the preferred permutations to be rapidly identified based on real-world user behavior. In particular, a set of web pages that include different permutations of the set of parameters are generated. Then, at least a subset of these web pages is provided to the users in response to their requests. For example, the requests may be associated with user selections of search results, which are associated with search queries provided by the users to a search engine. While the users interact with the subset of the set of web pages, their actions and the associated context (with respect to the different permutations) are tracked. Next, the tracked user actions are used to identify the web pages associated with the preferred permutations of the set of parameters.

By identifying the preferred permutations based on tracked user actions, the parameter-selection technique facilitates fast and accurate assessments of new products (such as a web page) and the associated features. This approach may also be used iteratively in a closed-loop system. For example, the identified preferred permutations may be used to revise the set of web pages (such as, by revising at least some of the permutations) and/or the user actions, and the search-engine results may be used to modify search-engine keywords associated with the set of web pages. In this way, the parameter-selection technique may iteratively converge on the preferred permutations that are associated with commercial success of a product. Consequently, the parameter-selection technique may: increase sales, improve customer satisfaction (and, thus, customer retention) and/or decrease time-to-market.

In the discussion that follows, the users may include a variety of entities, such as: an individual (for example, an existing customer, a new customer, a service provider, a vendor, a contractor, etc.), an organization, a business and/or a government agency. Furthermore, a ‘business’ should be understood to include: for-profit corporations, non-profit corporations, organizations, groups of individuals, sole proprietorships, government agencies, partnerships, etc.

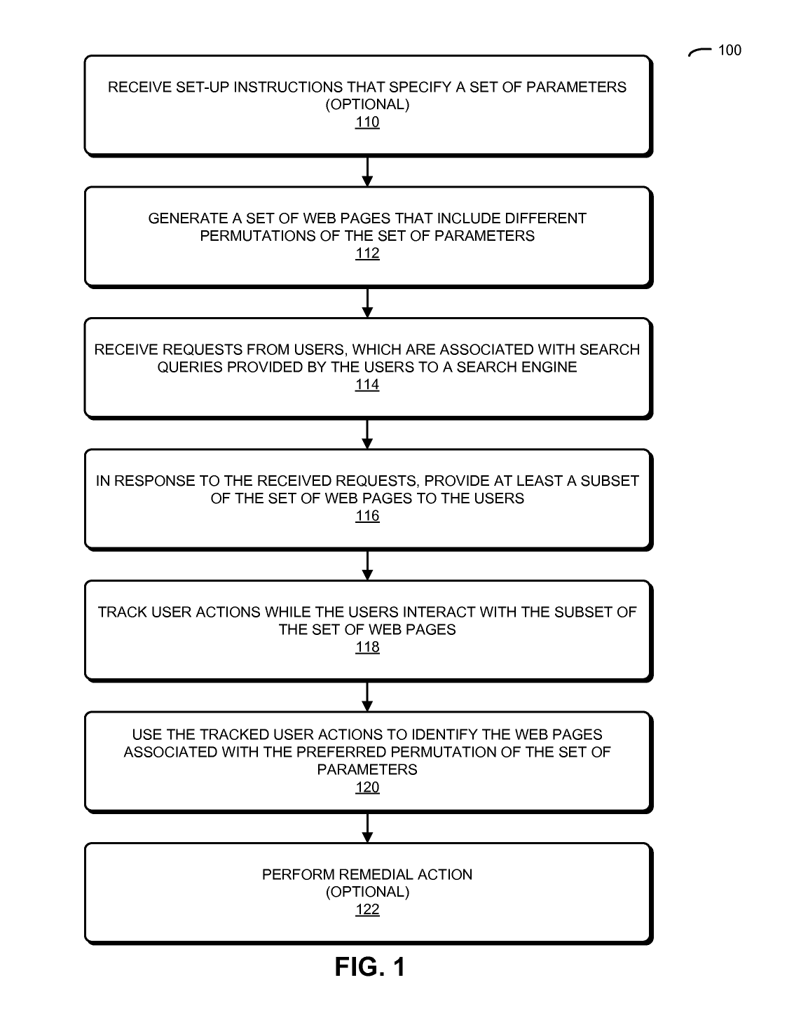

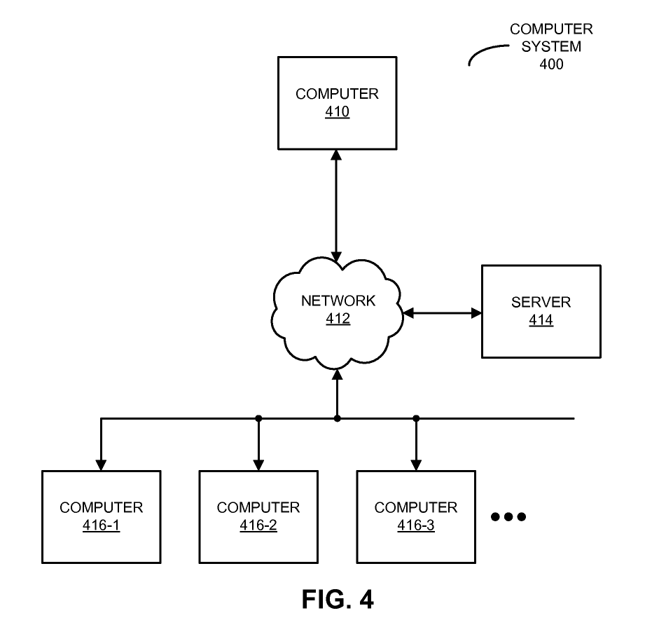

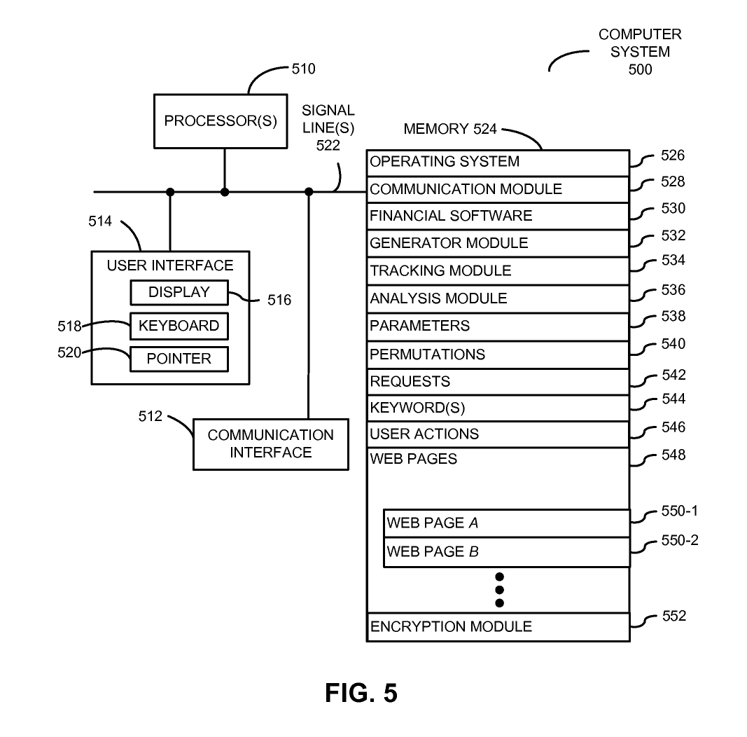

We now describe embodiments of the parameter-selection technique. FIG. 1 presents a flow chart illustrating a method 100 for identifying preferred permutations of a set of parameters for web pages, which may be performed by a computer system (such as computer systems 400 in FIG. 4 and/or 500 in FIG. 5). During operation, the computer system generates a set of web pages that include different permutations of the set of parameters (operation 112). Then, the computer system receives requests from users (operation 114), which are associated with search queries provided by the users to a search engine. For example, the requests may be associated with selections, by the users, of search results that are associated with the search queries. In response to the received requests, the computer system provides at least a subset of the set of web pages to the users (operation 116). Next, while the users interact with the subset of the set of web pages, the computer system tracks user actions (operation 118). Furthermore, the computer system uses the tracked user actions to identify the web pages associated with the preferred permutations of the set of parameters (operation 120).

In some embodiments, the computer system optionally receives set-up instructions that specify the set of parameters (operation 110) prior to generating the set of web pages. Moreover, the computer system may optionally perform remedial action based on the tracked user actions (operation 122). For example, the computer system may optionally revise the set of web pages based on the tracked user actions. These revisions may include modifying at least some of the permutations of the set of parameters. For example, these revisions may be performed iteratively to modify at least some of the permutations of the set of parameters based on information that is learned about the users' behaviors when the users interact with the set of web pages (such as from the tracked user actions). Alternatively or additionally, the computer system may optionally modify search-engine keywords associated with the set of web pages based on the search results and the user actions.

In some embodiments, the computer system optionally analyzes the user actions and the associated permutations of the set of parameters to identify the web pages associated with preferred permutations. For example, the analysis may include natural language processing of content associated with the user actions.

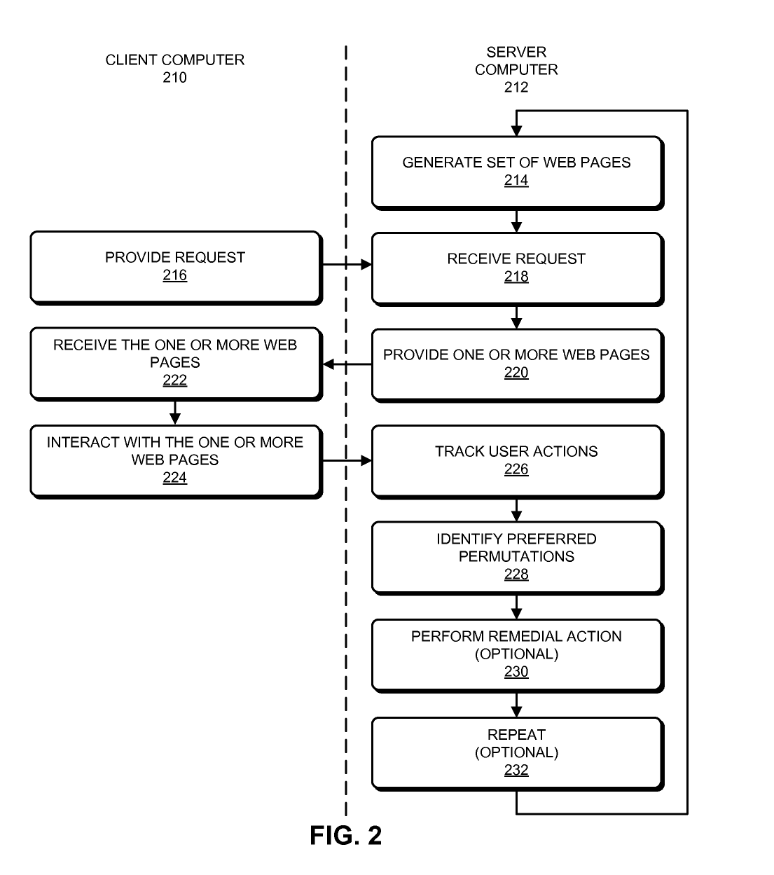

In an exemplary embodiment, the parameter-selection technique is implemented using one or more client computers and at least one server computer, which communicate through a network, such as the Internet (i.e., using a client-server architecture). This is illustrated in FIG. 2, which presents a flow chart illustrating method 100. During this method, server computer 212 generates the set of web pages (operation 214) based on the set of parameters (such as eXtensible Markup Language content which may have been previously specified by an administrator or an operator of server computer 212). In particular, a given web page in the set of web pages may include a different permutation of the set of parameters than some or all of the other web pages in the set of web pages. Then, a user of client computer 210 provides a request (operation 216). For example, the user may provide one or more search queries to a search engine (such as a search for content, a product and/or a service), and the request may be associated with user selection(s) of search results (such as a link to one or more web pages) that may be associated with a potential purchasing decision. Next, server computer 212 receives the request (operation 218) and, in response to the request, provides one or more of the web pages in the set of web pages (operation 220), i.e., a subset of the set of web pages.

Subsequently, the user receives the one or more web pages (operation 222). Then, the user interacts with the one or more web pages (operation 224). For example, the user may focus on a portion of a web page, may select different available options on a web page, may provide information into a field in a web page and/or may provide comments or feedback about a web page or a way to solve a problem (such as in a forum or a blog). These user actions may be tracked by server computer 212 (operation 226). In particular, using event tracking, server computer 212 may aggregate: user selections, user-provided information, context information (such as interesting portions of a web page where the user dwelled), spatial-relationship information (such as locations on web pages that the user interacted with relative to the set of parameters in these web pages) and/or temporal information associated with the user interaction with the web pages (such as how long the user viewed a web page).

Similar user actions may be tracked for multiple users who, respectively, requested and interacted with different subsets of the set of web pages. Using the tracked user actions, server computer 212 may identify preferred permutations (operation 228) in the set of web pages. For example, server computer 212 may analyze the user actions and the associated permutations of the set of parameters to identify the web pages associated with preferred permutations. In some embodiments, the analysis may include natural language processing (such as optical character recognition or speech recognition) of content associated with the user actions (such as comments or feedback about a web page that are provided by the user in a forum or a blog that is separate from the set of web pages). Note that when server computer 212 identifies the preferred permutations, it may prune or reduce the number of web pages in the set of web pages, for example, by: eliminating web pages, combining the permutations of the set of parameters in two or more of the web pages and/or modifying the permutations in at least one of the web pages in the set of web pages.

In some embodiments, server computer 212 optionally performs remedial action (operation 230). For example, the identified preferred permutations may be used to revise the set of web pages (such as, by revising at least some of the permutations). Alternatively or additionally, the user actions and/or the search-engine results may be used to modify search-engine keywords associated with the set of web pages. (Thus, method 100 may be used to facilitate search-engine optimization, in which traffic to the set of web pages via organic or paid search results from a search engine is enhanced and, more generally, to facilitate search-engine marketing, in which the visibility of the set of web pages in the results from the search engine is enhanced using techniques such as search-engine optimization.) This may improve the commercial success of one or more of the web pages by improving their relevance (as reflected by their subsequent page ranking by the search engine in the search results).

Furthermore, server computer 212 may optionally repeat (operation 232) the preceding operations one or more times, thereby allowing the preferred permutations to be identified iteratively over time in a closed-loop system, and allowing an optimal web page or web pages in the set of web pages (i.e., those that are preferred based on the user actions) to be selected. In this way, method 100 may conduct a series of experiments over time (including learning and re-testing) to validate ideas and to facilitate the commercial success of an eventual product by identifying the preferred market opportunities and solutions based on user behavior. This commercial success may allow an organization (such as a company) that provides a product or service associated with the set of web pages to increase sales, i.e., to expand its market share. Note that the user(s) targeted by the set of web pages may be potential new customers of the organization. For example, the user(s) may be existing customers of other products or services provided by the organization, but may not be an existing customer(s) of the product or service associated with the set of web pages.

In some embodiments of method 100 (FIGS. 1 and 2), there may be additional or fewer operations. Moreover, the order of the operations may be changed, and/or two or more operations may be combined into a single operation.

Method 100 may facilitate so-called ‘intelligent problem marketing’ that allows an organization to learn from what prospective customers (i.e., the users) are looking for and their behavior while interacting with potential solutions in the real world (such as while the prospective customers use their computers to surf the Internet). Thus, in contrast with a focus group, the users may interact with one or more of the web pages in the set of web pages without realizing that a test of a particular set of permutations is being conducted.

In an exemplary embodiment, a provider of software (such as financial software) may use this approach to identify preferred graphical user interface (GUI) features in the software. For example, the set of permutations may include a graphical view of expenses and a calendar view of expenses.

When the set of web pages are generated, these features may be included in different web pages that can be compared head-to-head in the marketplace (a so-called ‘split’ test) to determine which one is preferred by potential (i.e., new) customers using event tracking.

In another example, the financial software may be used for tracking time (such as time performed on a project) and associated billing (for example, for project management and reporting). There may be 30 features or parameters that can, in principle, be included in the software. The parameter-selection technique may be used to prioritize the features and, thus, to determine which ones to include in the financial software.

In another example, there may be multiple opportunities associated with different types of mobile applications. These opportunities may be represented by eXtensible Markup Language content. Using the parameter-selection technique, multiple variations on the mobile applications may be generated. These variations may be viewed by a number of prospective customers, and their click throughs may be measured to identify the preferred applications. For example, content sections in the applications that are associated with tradeshows, events, payment integration and the use of marketing lists may result in a larger response (as measured by the associated click-through rates) and viewing times. Therefore, these features or parameters may be deemed to be more important to the prospective customers (as opposed to other areas of focus, such as expense management, vendor relations and cash management/receipts, which had lower click-through rates and viewing times). In response to these measured user actions, server computer 212 (FIG. 2) may adjust the content in the applications (for example, by shifting or adding content or components) to further zero-in on the relative performance of content associated with: trade shows and events versus food vending, payment-related messages versus customer-acquisition messages, etc. Then, the testing may be repeated until the preferred permutations are identified.

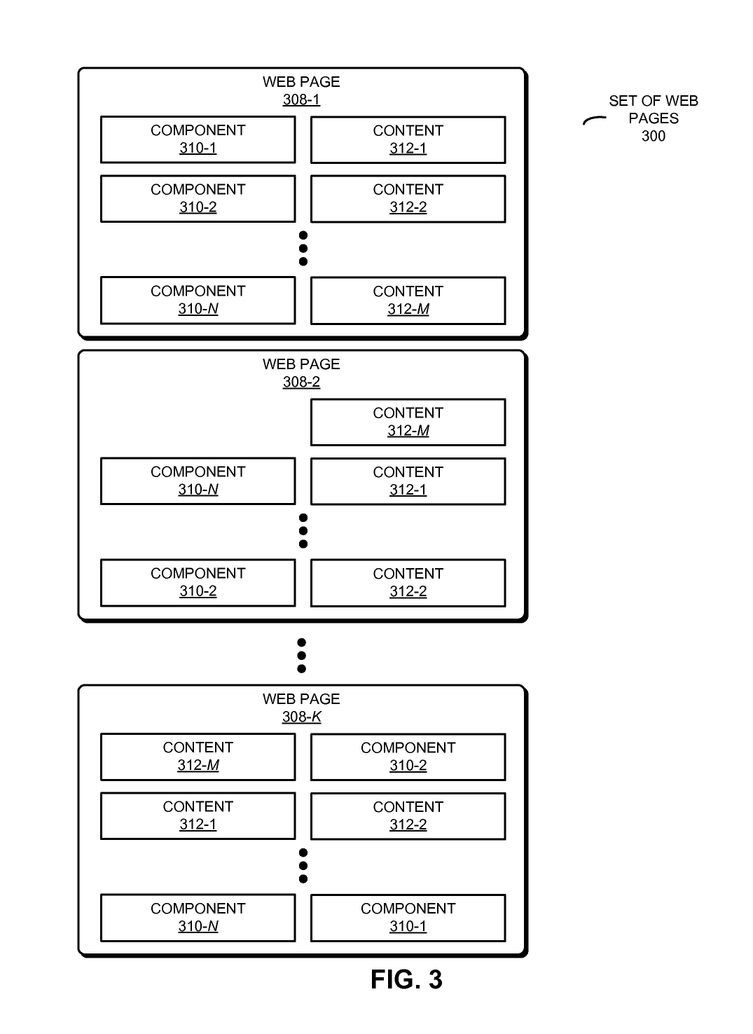

In another exemplary embodiment, an administrator logs in to a system to set up test parameters (for example by specifying eXtensible Markup Language content). This set of parameters may include: images, annotated flyovers, marketing content, etc. Then, a set of web pages may be generated with certain components, features or configurations (which are collectively referred to as ‘parameters’). For example, the set of web pages may include different permutations of five components, which each have five associated options (such as compatibility with: a cellular telephone, Twitter, etc.). This is shown in FIG. 3, which presents a block diagram illustrating a set of web pages 300. In particular, web pages 308 include different permutations of components 310 and content 312. Note that the permutations may include different subsets of the parameters, as well as different spatial configurations or ordering of the parameters. In general, the parameters may include: content 312, a sensory presentation format (e.g., look and feel, such as fonts, color, etc.), a web-page component (such as one of components 310) and/or a configuration of the web-page component. In some embodiments, generating the set of web pages includes generating keywords for a search engine and/or adwords (which help specify advertising messages that can be included in the set of web pages).

Then, the set of web pages may be posted on a network, such as the Internet. Subsequent user actions (mouse clicks, mouse position, contact with a touch screen, hovering, etc.) may be tracked (for example, via event tracking) to assess user responses to the set of web pages. Note that the tracked user actions may include the spatial and/or temporal context of their actions relative to the permutations of the set of parameters that they viewed. Furthermore, the tracked user actions may be used by a decision engine (such as an analysis module) to adapt or modify the set of parameters and/or to identify the preferred parameters. Note that the adapting and/or identifying may also be based on success factors, such as: page rank (and, more generally, the search-engine results), collaborative filtering, etc. For example, the analysis may involve a Bayesian inference technique.

Additionally, a recombination engine (such as a generator module) may use the preferred parameters to generate a revised set of web pages. For example, the number of web pages in the set of web pages may be reduced from ten to four. In some embodiments, regular expressions (such as Boolean logic that is associated with the components) define which components can be matched and their order, so the web-page generation progresses based on the user data (such as the tracked user actions). These revised web pages may then be tested to assess which ones work best with prospective customers. Thus, the parameter-selection technique may determine causal relationships between features on web pages and outcomes, and may use this information to adapt the web pages, for example, to improve their usefulness to potential customers, or to improve the page rankings of the web pages in a search engine.

Note that, if a user expresses an interest in purchasing a product or service associated with one of the set of web pages while the testing and refinement is ongoing, server computer 212 (FIG. 2) may collect the user's information and put them on a waiting list until the final product or service is available. Alternatively, the user may be allowed to purchase the product or service even while the testing and refinement is ongoing.

We now describe embodiments of the computer system and its use. FIG. 4 presents a block diagram illustrating a computer system 400 that performs method 100 (FIGS. 1 and 2). In this system, a user of computer 410 may use marketing-intelligence software to specify the set of parameters to server 414 via network 412. For example, the user may provide the set of parameters by interacting with a web page that is provided by server 414. Alternatively, the user may provide the set of parameters using a marketing-intelligence software application that is resident on and that executes on computer 410. This marketing-intelligence software application may be a stand-alone application or a portion of another application that is resident on and which executes on computer 410 (such as financial software that is provided by server 414 or that is installed and which executes on computer 410).

In some embodiments, at least a portion of the marketing-intelligence software application may be an application tool (such as a marketing-software application tool) that is embedded in the web page (and which executes in a virtual environment of the web browser). In an illustrative embodiment, the marketing-software application tool is a software package written in: JavaScript™ (a trademark of Oracle Corporation), e.g., the marketing-software application tool includes programs or procedures containing JavaScript instructions, ECMAScript (the specification for which is published by the European Computer Manufacturers Association International), VBScript™ (a trademark of Microsoft Corporation) or any other client-side scripting language. In other words, the embedded marketing-software application tool may include programs or procedures containing. JavaScript, ECMAScript instructions, VBScript instructions, or instructions in another programming language suitable for rendering by the web browser or another client application (such as on computer 410). Thus, the marketing-software application tool may be provided to the user via a client-server architecture.

As discussed previously, server 414 may generate the set of web pages based on the specified set of parameters. In an exemplary embodiment, the set of web pages are associated with the financial software.

Then, in response to the requests from users of computers 416, server 414 may provide subsets of the set of web pages to computers 416 via network 412, and may track user actions while the users interact with these subsets. Next, server 414 may identify the preferred permutations of the set of parameters, and may adapt or modify the set of parameters prior to revising the set of web pages. Furthermore, the process may be iterated one or more times in order to refine the identified preferred permutations, for example, based on information that is learned about users' behaviors when the users interact with the set of web pages (such as from the tracked user actions).

Note that the information in computer system 400 (such as the information about the user actions) may be stored at one or more locations in computer system 400 (i.e., locally or remotely). Moreover, because this information may be sensitive in nature, it may be encrypted. For example, stored information and/or information communicated via network 412 may be encrypted.

FIG. 5 presents a block diagram illustrating a computer system 500 that performs method 100 (FIGS. 1 and 2), such as server 414 (FIG. 4). Computer system 500 includes one or more processing units or processors 510, a communication interface 512, a user interface 514, and one or more signal lines 522 coupling these components together. Note that the one or more processors 510 may support parallel processing and/or multi-threaded operation, the communication interface 512 may have a persistent communication connection, and the one or more signal lines 522 may constitute a communication bus. Moreover, the user interface 514 may include: a display 516, a keyboard 518, and/or a pointer 520, such as a mouse.

Memory 524 in computer system 500 may include volatile memory and/or non-volatile memory. More specifically, memory 524 may include: ROM, RAM, EPROM, EEPROM, flash memory, one or more smart cards, one or more magnetic disc storage devices, and/or one or more optical storage devices. Memory 524 may store an operating system 526 that includes procedures (or a set of instructions) for handling various basic system services for performing hardware-dependent tasks. Memory 524 may also store procedures (or a set of instructions) in a communication module 528. These communication procedures may be used for communicating with one or more computers and/or servers, including computers and/or servers that are remotely located with respect to computer system 500. While not shown in FIG. 5, in some embodiments memory 524 includes a web browser.

Memory 524 may also include multiple program modules (or sets of instructions), including: financial software 530 (or a set of instructions), generator module 532 (or a set of instructions), tracking module 534 (or a set of instructions), analysis module 536 (or a set of instructions), and/or encryption module 552 (or a set of instructions). Note that one or more of these program modules (or sets of instructions) may constitute a computer-program mechanism.

During method 100 (FIGS. 1 and 2), an administrator may specify parameters 538 and/or permutations 540 (for example, via a web page provided by financial software 530). Then, generator module 532 may generate web pages 548 based on permutations 540 or parameters 538. These web pages may include web page A 550-1 and web page B 550-2. In addition, generator module 532 may generate one or more keywords 544 associated with web pages 548, which may improve search-engine results associated with web pages 548 and/or may assist a search engine in identifying paid advertising for inclusion in web pages 548. Note that this search engine may be provided by the operator of computer system 500 or a third party.

Next, users may provide requests 542, such as requests associated with user selections of search results, which, in turn, are associated with search queries provided by the users to the search engine. In response to requests 542, financial software 530 may provide one or more web pages 548 to the users. (For example, the web pages may be associated with different variations on a product or service associated with financial software 530.) While interacting with these web pages, tracking module 534 may track user actions 546 (for example, using event tracking). These tracked user actions may be stored in a non-transitory, computer-readable data structure.

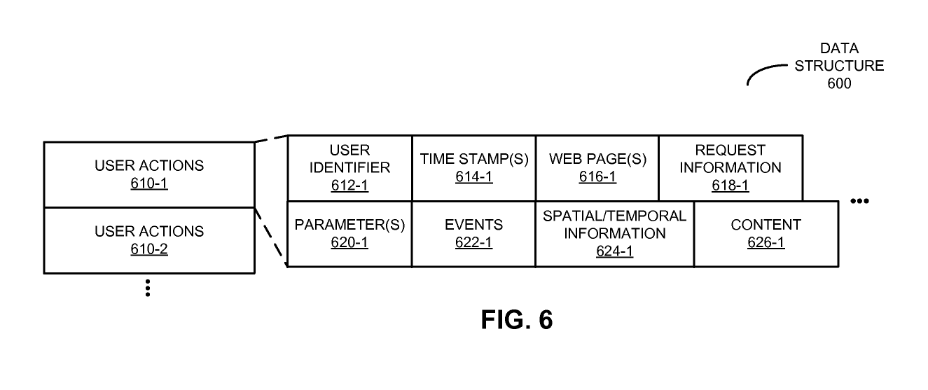

This data structure is shown in FIG. 6, which presents a block diagram illustrating a data structure 600. In particular, data structure 600 may include information about user actions 610 for different users. For example, user actions 610-1 may include: a user identifier 612-1, one or more time stamps 614-1 associated with tracked events 622-1, one or more web pages 616-1 that the user interacted with, request information 618-1 (such as search queries provided by the user and/or selection of search results by the user), parameters 620-1 that were used to generate web pages 616-1, tracked events 622-1, spatial and temporal information 624-1 that relate tracked events 622-1 to parameters 620-1 or web pages 616-1, and/or content 626-1 provided by the users to web pages 616-1 or to a separate web page or forum.

Referring back to FIG. 5, user actions 546 may be used by analysis module 536 to identify preferred parameters in parameters 538. In addition, generator module 532 may use tracked user actions 546 to revise web pages 548 and/or one or more keywords 544, which may be used in subsequent iterations of method 100 (FIGS. 1 and 2).

Furthermore, because the information about web pages 548 may be sensitive in nature, in some embodiments at least some of the information stored in memory 524 and/or at least some of the information communicated using communication module 528 is encrypted using encryption module 552. Additionally, in some embodiments one or more of the modules in memory 524 may be included in financial software 530.

Instructions in the various modules in memory 524 may be implemented in: a high-level procedural language, an object-oriented programming language, and/or in an assembly or machine language. Note that the programming language may be compiled or interpreted, e.g., configurable or configured, to be executed by the one or more processors 510.

Although computer system 500 is illustrated as having a number of discrete items, FIG. 5 is intended to be a functional description of the various features that may be present in computer system 500 rather than a structural schematic of the embodiments described herein. In practice, and as recognized by those of ordinary skill in the art, the functions of computer system 500 may be distributed over a large number of servers or computers, with various groups of the servers or computers performing particular subsets of the functions. In some embodiments, some or all of the functionality of computer system 500 may be implemented in one or more application-specific integrated circuits (ASICs) and/or one or more digital signal processors (DSPs).

Computers and servers in computer systems 400 (FIG. 4) and/or 500 may include one of a variety of devices capable of manipulating computer-readable data or communicating such data between two or more computing systems over a network, including: a personal computer, a laptop computer, a mainframe computer, a portable electronic device (such as a cellular phone or PDA), a server and/or a client computer (in a client-server architecture). Moreover, network 412 (FIG. 4) may include: the Internet, World Wide Web (WWW), an intranet, LAN, WAN, MAN, or a combination of networks, or other technology enabling communication between computing systems.

In exemplary embodiments, the financial-software application (i.e., financial software 530) includes: Quicken™ and/or TurboTax™ (from Intuit, Inc., of Mountain View, Calif.), Microsoft Money™ (from Microsoft Corporation, of Redmond, Wash.), SplashMoney™ (from SplashData, Inc., of Los Gatos, Calif.), Mvelopes™ (from In2M, Inc., of Draper, Utah), and/or open-source applications such as Gnucash™, PLCash™, Budget™ (from Snowmint Creative Solutions, LLC, of St. Paul, Minn.), and/or other planning software capable of processing financial information.

Moreover, the financial-software application may include software such as: QuickBooks™ (from Intuit, Inc., of Mountain View, Calif.), Peachtree™ (from The Sage Group PLC, of Newcastle Upon Tyne, the United Kingdom), Peachtree Complete™ (from The Sage Group PLC, of Newcastle Upon Tyne, the United Kingdom), MYOB Business Essentials™ (from MYOB US, Inc., of Rockaway, N.J.), NetSuite Small Business Accounting™ (from NetSuite, Inc., of San Mateo, Calif.), Cougar Mountain™ (from Cougar Mountain Software, of Boise, Id.), Microsoft Office Accounting™ (from Microsoft Corporation, of Redmond, Wash.), Simply Accounting™ (from The Sage Group PLC, of Newcastle Upon Tyne, the United Kingdom), CYMA IV Accounting™ (from CYMA Systems, Inc., of Tempe, Ariz.), DacEasy™ (from Sage Software SB, Inc., of Lawrenceville, Ga.), Microsoft Money™ (from Microsoft Corporation, of Redmond, Wash.), Tally.ERP (from Tally Solutions, Ltd., of Bangalore, India) and/or other payroll or accounting software capable of processing payroll information.

Set of web pages 300 (FIG. 3), computer system 400 (FIG. 4), computer system 500 and/or data structure 600 (FIG. 6) may include fewer components or additional components. Moreover, two or more components may be combined into a single component, and/or a position of one or more components may be changed. In some embodiments, the functionality of computer systems 400 (FIG. 4) and/or 500 may be implemented more in hardware and less in software, or less in hardware and more in software, as is known in the art.

While the preceding discussion illustrated the use of the parameter-selection technique to identify the preferred permutations of the set of parameters in a set of web pages, more generally this approach may be used to facilitate efficient and accurate split testing of a wide variety of products or solutions (including products other than software), as well as closed-loop adaptation of a product or a service based on tracked user actions. These other applications may include identifying the preferred: ingredients in foods, services associated with a product (such a guarantee, availability on-line or in-store, etc.) and/or marketing content associated with a product or a service (such as logo placement, a slogan, etc.).

The foregoing description is intended to enable any person skilled in the art to make and use the disclosure, and is provided in the context of a particular application and its requirements. Moreover, the foregoing descriptions of embodiments of the present disclosure have been presented for purposes of illustration and description only. They are not intended to be exhaustive or to limit the present disclosure to the forms disclosed. Accordingly, many modifications and variations will be apparent to practitioners skilled in the art, and the general principles defined herein may be applied to other embodiments and applications without departing from the spirit and scope of the present disclosure. Additionally, the discussion of the preceding embodiments is not intended to limit the present disclosure. Thus, the present disclosure is not intended to be limited to the embodiments shown, but is to be accorded the widest scope consistent with the principles and features disclosed herein.

What is claimed is:

1. A computer-implemented method for identifying preferred permutations of a set of parameters for web pages, comprising:
generating, using a computer, a set of web pages that include different permutations of the set of parameters;
receiving requests from users, wherein the requests are associated with search queries provided by the users to a search engine;
providing at least a subset of the set of web pages to the users in response to the received requests;
tracking user actions while the users interact with the subset of the set of web pages; and
using the tracked user actions to identify the web pages associated with the preferred permutations of the set of parameters.

2. The method of claim 1, wherein the method further comprises receiving set-up instructions that specify the set of parameters.

3. The method of claim 1, wherein the set of parameters include content, a sensory presentation format, a web-page component and a configuration of the web-page component.

4. The method of claim 1, wherein the requests are associated with selections, by the users, of search results that are associated with the search queries.

5. The method of claim 1, wherein the method further includes modifying search-engine keywords associated with the set of web pages based on the search results and the user actions.

6. The method of claim 1, wherein tracking the user actions involves event tracking.

7. The method of claim 1, wherein the user actions include user selections and information provided in fields in the set of web pages.

8. The method of claim 1, wherein the user actions include context information associated with the permutations of the set of parameters in the subset of the set of web pages, spatial-relationship information for locations that the users interact with relative to the permutations of the set of parameters in the subset of the set of web pages, and temporal information associated with the user interaction with the subset of the set of web pages.

9. The method of claim 1, wherein the method further includes analyzing the user actions and the associated permutations of the set of parameters to identify the web pages associated with preferred permutations.

10. The method of claim 9, wherein the analysis includes natural language processing of content associated with the user actions.

11. The method of claim 1, wherein the preferred permutations are associated with commercial success of a product.

12. The method of claim 1, wherein the users are other than existing customers of a product associated with the set of web pages.

13. The method of claim 1, wherein the method further includes revising the set of web pages based on the tracked user actions.

14. The method of claim 13, wherein the revising is performed iteratively based on the tracked user actions.

15. The method of claim 13, wherein revising the set of web pages includes modifying at least some of the permutations of the set of parameters.

16. A non-transitory computer-program product for use in conjunction with a computer system, the computer-program product comprising a computer-readable storage medium and a computer-program mechanism embedded therein to identify preferred permutations of a set of parameters for web pages, the computer-program mechanism including:
instructions for generating a set of web pages that include different permutations of the set of parameters;
instructions for receiving requests from users, wherein the requests are associated with search queries provided by the users to a search engine;
instructions for providing at least a subset of the set of web pages to users in response to the received requests;
instructions for tracking user actions while the users interact with the subset of the set of web pages; and
instructions for using the tracked user actions to identify the web pages associated with the preferred permutations of the set of parameters.

17. The computer-program product of claim 16, wherein the requests are associated with selections, by the users, of search results that are associated with the search queries.

18. The computer-program product of claim 16, wherein the computer-program mechanism includes instructions for modifying search-engine keywords associated with the set of web pages based on the search results and the user actions.

19. The computer-program product of claim 16, wherein the user actions include user selections and information provided in fields in the set of web pages.

20. The computer-program product of claim 16, wherein the computer-program mechanism includes instructions for analyzing the user actions and the associated permutations of the set of parameters to identify the web pages associated with the preferred permutations.

21. A computer system, comprising:
a processor;
memory; and
a program module, wherein the program module is stored in the memory and configurable to be executed by the processor to identify preferred permutations of a set of parameters for web pages, the program module including:
instructions for generating a set of web pages that include different permutations of the set of parameters;
instructions for receiving requests from users, wherein the requests are associated with search queries provided by the users to a search engine;
instructions for providing at least a subset of the set of web pages to users in response to the received requests;
instructions for tracking user actions while the users interact with the subset of the set of web pages; and
instructions for using the tracked user actions to identify the web pages associated with the preferred permutations of the set of parameters.
